(19) United States
(12) Patent Application Publication
(10) Pub. No.: US 2012/0303856 A1
(43) Pub. Date: Nov. 29, 2012

(54) SEMICONDUCTOR DEVICE AND METHOD OF CONTROLLING THE SAME

(75) Inventors: Naoki Nakanose, Kanagawa (JP); Kuniyasu Ishihara, Kanagawa (JP); Ryoichi Yamaguchi, Kanagawa (JP)

(73) Assignee: Renesas Electronics Corporation

(21) Appl. No.: 13/474,281

(22) Filed: May 17, 2012

(30) Foreign Application Priority Data
May 23, 2011 (JP) JP 2011-114344

(51) Int. Cl. G06F 13/28

(52) U.S. Cl. 710/308

(57) ABSTRACT

A microcomputer includes a CPU (Central Processing Unit), a DMA (Direct Memory Access) processing unit, and a control unit. The control unit controls a processing speed of the CPU to be faster as the number of holding transfers increases, in which the number of holding transfers is the number of DMA transfers held to the DMA processing unit.

### CROSS-REFERENCE TO RELATED APPLICATIONS

This application is based upon and claims the benefit of priority from Japanese patent application No. 2011-114344, filed on May 23, 2011, the disclosure of which is incorporated herein in its entirety by reference.

### BACKGROUND

The present invention relates to a semiconductor device, and particularly to a control technique for a semiconductor device including a CPU (Central Processing Unit) and a DMA transfer processing unit for performing DMA transfer.

In recent years, developers of microcomputers are always facing two issues, which are speeding up of the processes and reduction of power consumption, and techniques have been suggested from various viewpoints (as in Japanese Unexamined Patent Application Publication Nos. 2010-015233 and 11-024782).

For example, Japanese Unexamined Patent Application Publication No. 11-024782 discloses a technique to increase the frequency of a main clock in the microprocessor when calculation delay accumulated through the calculation processes increases and reduce the frequency of the main clock when the calculation delay decreases at the time a CPU (microprocessor) performs the calculation operation.

The higher the processing speed of the CPU, the larger the power consumption by the CPU. Thus, adjusting the processing speed of the CPU can adjust the power consumption of the CPU.

The technique of adjusting the processing speed of the CPU by adjusting voltage supplied to the CPU is also known. For example, Japanese Unexamined Patent Application Publication No. 2009-260612 discloses that in a CPU composed of an asynchronous circuit (hereinafter referred to as an asynchronous CPU), the processing speed of the asynchronous circuit is measured, and according to the measured processing speed, the voltage is reduced when the processing speed is higher than the target speed and the voltage is reduced when the processing speed is lower than the target speed. This maintains the processing speed of the CPU composed of the asynchronous circuit constant at the target speed.

Moreover, DMA (Direct Memory Access) is known as an ancillary technique at the time of the low speed process of the CPU. The DMA is a technique that directly accesses to the memory not through the CPU and is capable of execution in the background of CPU processes, thereby increasing the processing speed of the entire microcomputer even when the CPU processes are performed at a low speed. Further, as the memory can be accessed by the DMA even when the CPU is in a standby state, applying the DMA is effective for reducing the power consumption of the microcomputer.

### SUMMARY

When the DMA transfer is performed while the CPU is operating, in order to avoid contention between the memory access from the CPU and the DMA transfer, the operation must be performed while arbitrating bus occupation between the memory access from the CPU and the memory access by the DMA. In general, when the processing speed of the CPU is reduced, the bus occupying time by the CPU increases, and thereby reducing the speed of the DMA transfer.

An aspect of the present invention is a control method. For a semiconductor device including a DMA processing unit for performing DMA transfer, the control method controls a processing speed of the CPU to be higher as the number of holding transfers increases, in which the number of holding transfers is the number of DMA transfers held to the DMA processing unit.

A circuit, an apparatus, and a system including the apparatus for executing the method of the above aspect are also effective as the aspect of the present invention.

The technique according to the present invention enables balanced control of the processing speed of the CPU and the speed of DMA transfer in the semiconductor device mounted with the DMA function.

### BRIEF DESCRIPTION OF THE DRAWINGS

The above and other aspects, advantages and features will be more apparent from the following description of certain embodiments taken in conjunction with the accompanying drawings, in which:

FIG. 1 is a view showing a microcomputer according to a first embodiment of the present invention;

FIG. 2 is a flowchart showing a process of a control unit in the microcomputer shown in FIG. 1;

FIG. 3 is a view showing a microcomputer according to a second embodiment of the present invention; and

FIG. 4 is a flowchart showing a flow of a process in the microcomputer shown in FIG. 3.

### DETAILED DESCRIPTION

Hereinafter, embodiments of the present invention are described with reference to the drawings. The following description and the drawings are omitted and simplified as appropriate for the clarity of the explanation. Note that the same components are denoted by the reference numerals and repeated explanation is omitted as necessary.

### First Embodiment

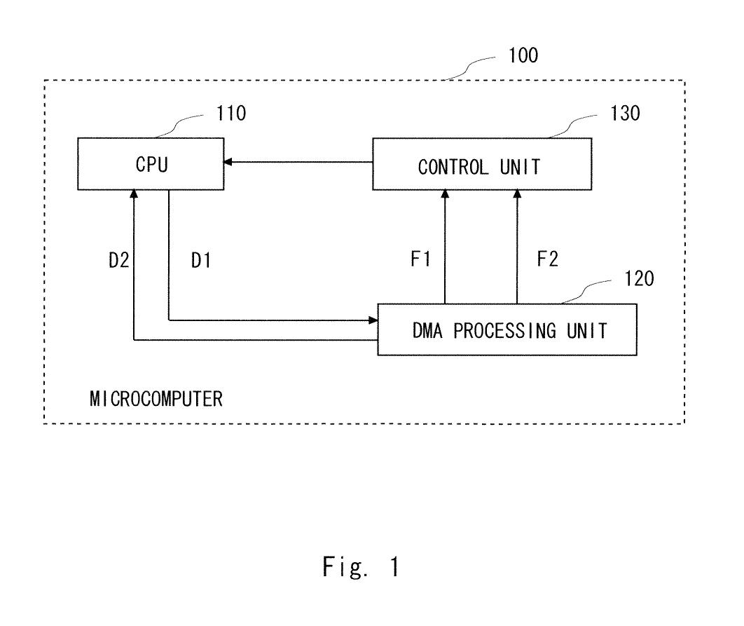

FIG. 1 shows a microcomputer 100 according to a first embodiment of the present invention. The microcomputer 100 includes a CPU 110, a DMA processing unit 120 for performing DMA transfer, and a control unit 130. Note that a memory, a bus, and the like that are usually included in the microcomputer are not shown in the drawings.

The control unit 130 is connected to the CPU 110 by a bus not shown and controls the processing speed of the CPU 110. The processing speed control method for the CPU 110 by the control unit 130 may be any known methods. For example, the processing speed of the CPU 110 is controlled by adjusting the frequency of the clock or the voltage supplied to the CPU 110. Note that this control is performed according to the number of DMA transfers that are held to the DMA processing unit 120 (hereinafter referred to as “the number of holding transfers NUM”).

When the CPU 110 causes the DMA processing unit 120 to perform the DMA transfer, the CPU 110 outputs a DMA transfer request signal D1 to the DMA processing unit 120. In response to the DMA transfer request signal D1, the DMA processing unit 120 returns a DMA transfer permission signal D2 to the CPU 110 when the DMA transfer can be performed.

In this embodiment, the DMA processing unit 120 further outputs a transfer request flag F1 and a transfer completion flag F2 to the control unit 130. The transfer request flag F1 is output by the DMA processing unit 120 every time the DMA transfer is requested from the CPU 110. The transfer completion flag F2 is output every time the DMA processing unit 120 completes the DMA transfer. That is, the total number of the transfer request flags F1 is the number of DMA transfer requests for the DMA processing unit 120, and the total number of transfer completion flags F2 is the number of the DMA transfers completed by the DMA processing unit 120.

The control unit 130 obtains the total number of transfer request flags F1 and the total number of transfer completion flags F2 from the DMA processing unit 120, and calculates the value obtained by subtracting the total number of transfer completion flags F2 from the total number of transfer request flags F1 as the abovementioned number of holding transfers NUM.

Then, the control unit 130 controls the processing speed of the CPU 110 to be higher as the number of holding transfers NUM increases.

In this embodiment, the control unit 130 controls the processing speed of the CPU 110 in three stages. Specifically, the control unit 130 controls the processing speed of the CPU 110 so that a processing speed V1 is used when the number of holding transfers NUM is less than a threshold T1, a processing speed V2 is used when the number of holding transfers NUM is the threshold T1 or greater and less than a threshold T2, and a processing speed V3 is used when the number of holding transfers NUM is a threshold T2 or greater. Note that the threshold T2 is greater than T1, and the processing speeds V1, V2, and V3 are in order of speed, from slowest to fastest.

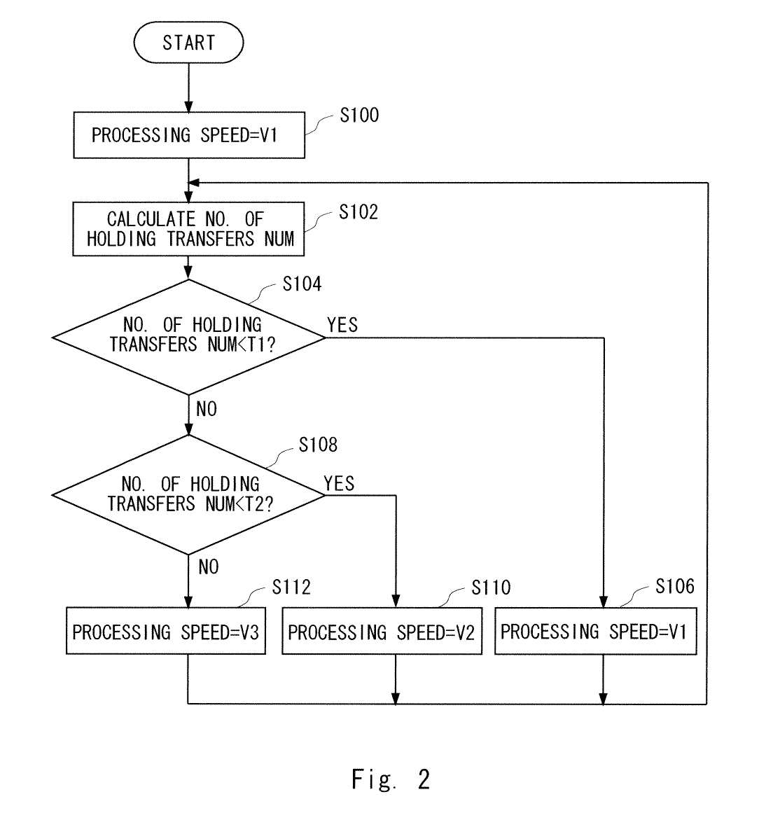

FIG. 2 is an example of a flowchart showing the control process by the control unit 130 in the microcomputer 100. Note that in the example shown in FIG. 2, the control unit 130 sets the processing speed of the CPU 110 to the lowest processing speed V1 in the initial setting.

As shown in FIG. 2, immediately after the microcomputer 100 starts operating, the control unit 130 controls the processing speed of the CPU 110 to be the processing speed V1 according to the initial setting (S100). After that, the control unit 130 calculates the number of holding transfers NUM, which is the difference between the total number of transfer request flags F1 and the total number of transfer completion flags F2 (S102).

When the number of holding transfers NUM is less than the threshold T1, the control unit 130 does not change but maintains the processing speed at the processing speed V1 (S104: Yes and S106). Then, the process returns to the step S102 for calculating the number of holding transfers NUM.

When the number of holding transfers NUM is the threshold T1 or greater and less than the threshold T2, the control unit 130 controls the processing speed of the CPU 110 to be the processing speed V2 (S104: No, S108: Yes, and S110). Then, the process returns to the step S102 for calculating the number of holding transfers NUM.

When the number of holding transfers NUM is T2 or greater, the control unit 130 controls the processing speed of the CPU 110 to be the processing speed V3 (S104: No, S108: No, and S112). Then, the process returns to the step S102 for calculating the number of holding transfers NUM.

After that, calculation of the number of holding transfers NUM and adjustment of the processing speed of the CPU 110 according to the calculated number of holding transfers NUM is repeated (from S102).

As described so far, in the microcomputer 100 according to this embodiment, the control unit 130 controls the processing speed of the CPU 110 to be higher as the number of holding transfers NUM increases according to the number of holding transfers NUM of the DMA transfer performed by the DMA processing unit 120. Therefore, while suppressing the current consumption by reducing the processing speed of the CPU 110 when the number of holding transfers NUM is small, excessive reduction in the processing speed of the entire microcomputer 100 is avoided by increasing the processing speed of the CPU 110 when the number of holding transfers NUM is large.

### Second Embodiment

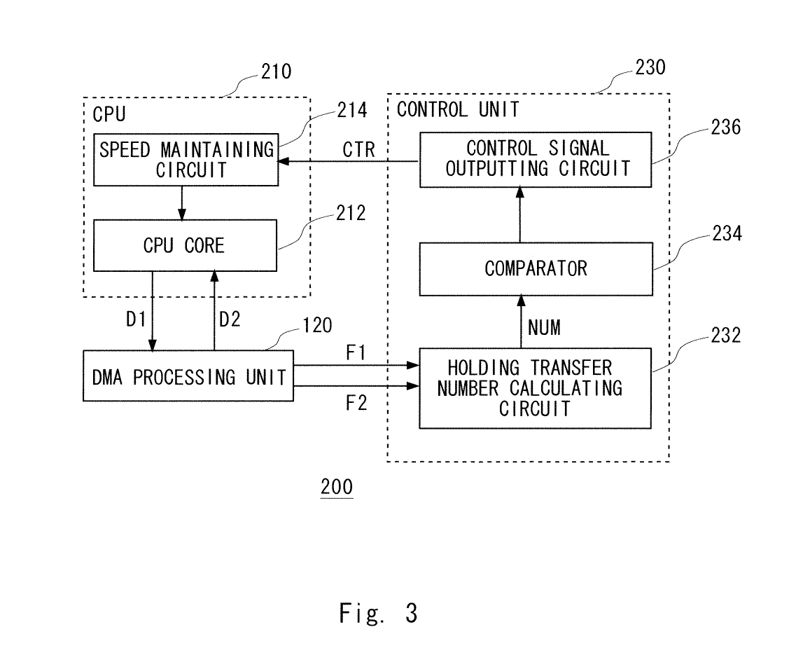

FIG. 3 shows a microcomputer 200 according to a second embodiment of the present invention. The microcomputer 200 includes a CPU 210, a DMA processing unit 120, and a control unit 230.

The DMA processing unit 120 is the same as the DMA processing unit 120 in the microcomputer 100 according to the first embodiment.

The CPU 210 includes a CPU core 212 and a speed maintaining circuit 214.

The CPU core 212 is asynchronous that is composed of an asynchronous circuit.

The asynchronous circuit is known that the processing speed varies due to environmental factors such as a temperature, manufacturing variation of chips, and the like. Therefore, the CPU core 212 does not have a constant processing speed, either.

The speed maintaining circuit 214 maintains the processing speed of the CPU core 212 constant. For example, as disclosed in Japanese Unexamined Patent Application Publication No. 2009-260612, the processing speed of the CPU core 212 is measured, and according to the measured processing speed, the voltage is reduced when the processing speed is higher than the target speed and the voltage is increased when the processing speed is lower than the target speed, so as to adjust the voltage supplied to the CPU core 212. This maintains the processing speed of the CPU core 212 constant at the target speed.

In the microcomputer 200 of this embodiment, the speed maintaining circuit 214 maintains the processing speed of the CPU core 212 at a predetermined speed, which is lower or equal to the lowest speed within the range in which the processing speed of the CPU core 212 varies.

A control signal CTR from the control unit 230 controls whether the speed maintaining circuit 214 operates or not. When the speed maintaining circuit 214 does not operate, the processing speed of the CPU core 212 varies in a similar manner as the normal asynchronous CPU. However once the speed maintaining circuit 214 operates, the processing speed of the CPU core 212 is maintained at the predetermined speed.

In the following explanation, the modes of the CPU 210 indicate whether or not the speed maintaining circuit 214 operates. The case in which the speed maintaining circuit 214 does not operate is referred to as an “asynchronous mode” of the CPU 210, and the case in which the speed maintaining circuit 214 operates is referred to as a “constant speed mode” of the CPU 210. When the CPU 210 is in the “constant speed mode”, the processing speed of the CPU core 212 is lower than or equal to the lowest speed when the CPU 210 is in the “asynchronous mode”.

The control unit 230 includes a holding transfer number calculating circuit 232, a comparator 234, and a control signal outputting circuit 236.

The holding transfer number calculating circuit 232 calculates a difference between the total number of transfer request flags F1 and the total number of transfer completion flags F2 from the DMA processing unit 120 as the number of holding transfers NUM and outputs the number of holding transfers NUM to the comparator 234.

The comparator 234 compares the number of holding transfers NUM from the holding transfer number calculating circuit 232 with a threshold, and outputs the comparison result to the control signal outputting circuit 236. In this embodiment, the comparator 234 uses different thresholds according to the modes of the CPU 210. When the CPU 210 is in the “constant speed mode”, the comparator 234 uses a predetermined threshold T1 (for example, five), and when the CPU 210 is in the “asynchronous mode”, the comparator 234 uses a smaller threshold T2 (for example, three) than the threshold T1.

The control signal outputting circuit 236 controls whether or not to switch the mode of the CPU 210 according to the comparison result by the comparator 234.

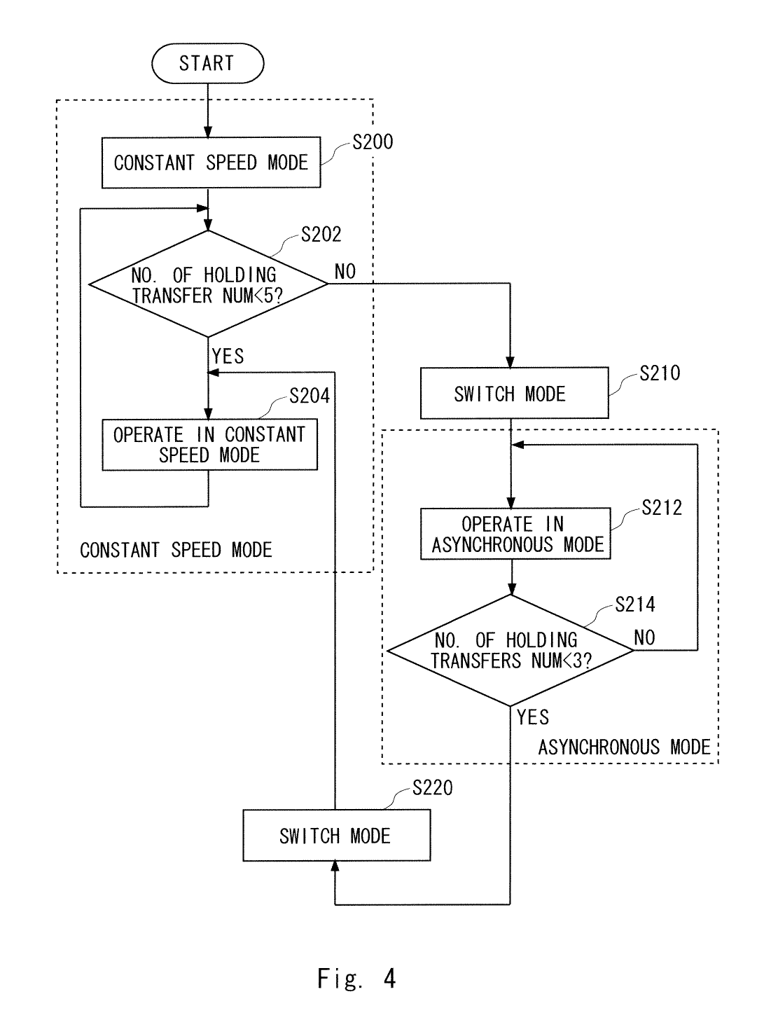

FIG. 4 is an example of a flowchart showing the process in the microcomputer 200. Note that in the example shown in FIG. 4, the control unit 230 sets the CPU 210 to the “constant speed mode” in the initial setting.

As shown in FIG. 4, the microcomputer 200 operates in the “constant speed mode” immediately after the operation starts, that is, the speed maintaining circuit 214 operates (S200).

As a result of comparison between the number of holding transfers NUM and the threshold T1(5) by the comparator 234, when the number of holding transfers NUM is less than five, the control signal outputting circuit 236 does not turn on the control signal CTR. Then, the speed maintaining circuit 214 continues to operate, and the CPU 210 continues to operate in the “constant speed mode” (S202:Yes and S204).

On the other hand, when the number of holding transfers NUM becomes five or greater in the step S202 (S202: No), the control signal outputting circuit 236 turns on the control signal CTR. Then, the speed maintaining circuit 214 stops the operation, and the CPU 210 switches from the “constant speed mode” to the “asynchronous mode” (S210 and S212).

While the CPU 210 is operating in the “asynchronous mode”, when the number of holding transfers NUM is the threshold T2(3) or greater (S215: No), the control signal outputting circuit 236 does not turn on the control signal CTR. Then, the speed maintaining circuit 214 continues to stop the operation, and the CPU 210 continues to operate in the “asynchronous mode” (S212).

On the other hand, in the step S214, when the number of holding transfers NUM becomes three or less (S214: No), the control signal outputting circuit 236 turns on the control signal CTR. Then, the speed maintaining circuit 214 starts the operation, and the CPU 210 switches from the “asynchronous mode” to the “constant speed mode” (S220 and S204).

As described above, in the microcomputer of this embodiment, while the CPU 210 is operating in the “constant speed mode” with the low processing speed, when the number of holding transfers NUM of the DMA processing unit 120 becomes five or greater, the control unit 230 switches the operation mode of the CPU 210 to the “asynchronous mode” with the high processing speed. Further, while the CPU 210 is operating in the “asynchronous mode” with the high processing speed, when the number of holding transfers NUM of the DMA processing unit 120 becomes less than three, the control unit 230 switches the operation mode of the CPU 210 to the “constant speed mode” with the low processing speed. Therefore, while suppressing the current consumption when the number of holding transfers NUM is small, excessive reduction in the processing speed of the entire microcomputer 200 can be avoided.

While the invention has been described in terms of several embodiments, those skilled in the art will recognize that the invention can be practiced with various modifications within the spirit and scope of the appended claims and the invention is not limited to the examples described above.

Further, the first and second embodiments can be combined as desirable by one of ordinary skill in the art.

Further, the scope of the claims is not limited by the embodiments described above.

Furthermore, it is noted that, Applicant's intent is to encompass equivalents of all claim elements, even if amended later during prosecution.

For example, in the microcomputer 100, although the frequency of the clock and voltage supplied to the CPU 110 are mentioned as a method of adjusting the processing speed of the CPU 110, the technique according to the present invention can be applied to cases of adjusting the processing speed of the CPU by any method.

Further, in the microcomputer 200, although the speed maintaining circuit 214 maintains the processing speed of the CPU core 212 constant by adjusting the voltage supplied to the CPU core 212 composed of the asynchronous circuit, the technique according to the present invention can be applied to a CPU including a mode for maintaining the processing speed of the asynchronous CPU core constant by any method.

What is claimed is:

1. A semiconductor device comprising:
a CPU (Central Processing Unit);
a DMA (Direct Memory Access) processing unit that performs DMA transfer; and
a control unit that controls a processing speed of the CPU, wherein
the control unit controls the processing speed of the CPU to be higher as the number of holding transfers increases, and the number of holding transfers is the number of DMA transfers held to the DMA processing unit.

2. The semiconductor device according to claim 1, wherein the control unit obtains a difference between the number of DMA transfer requests for the DMA processing unit and the number of DMA transfers completed by the DMA processing unit as the number of holding transfers.

3. The semiconductor device according to claim 1, wherein
the CPU includes a plurality of operation modes each with the processing speed that is different from each other, and
the control unit switches the operation mode of the CPU according to the number of holding transfers.

4. The semiconductor device according to claim 2, wherein
the CPU includes a plurality of operation modes each with the processing speed that is different from each other, and
the control unit switches the operation mode of the CPU according to the number of holding transfers.

5. A control method for a semiconductor device including a CPU (Central Processing Unit) and a DMA (Direct Memory Access) processing unit for performing DMA transfer, the control method comprising controlling a processing speed of the CPU to be higher as the number of holding transfers increases, the number of holding transfers being the number of DMA transfers held to the DMA processing unit.
